(19) United States
(12) Patent Application Publication
(10) Pub. No.: US 2004/0126494 A1
(43) Pub. Date: Jul. 1, 2004

(54) Duplex holographic film

(75) Inventors: Peter Maurits Maria Van Geert, Kraainem (BE); Patrick Jean-Francois Etesse, Brussels (BE)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/731,937

(22) Filed: Dec. 10, 2003

Related U.S. Application Data
(63) Continuation of application No. 09/857,958, filed on Jun. 12, 2001, now abandoned.

(30) Foreign Application Priority Data
Dec. 14, 1998 (EP) 98870270.0

(51) Int. Cl. B05D 1/36; B05D 5/00

(52) U.S. Cl. 427/258; 427/402

(57) ABSTRACT

The present invention relates to an holographic structure comprising an organic solvent based embossed layer, a metallic layer located onto the embossed layer, and an organic solvent based printing ink layer characterised in that the printing ink layer and the metallic layer are solely separated by a water solvent based primer.

### CROSS REFERENCE TO RELATED APPLICATIONS

This application is a continuation of U.S. application Ser. No. 09/857,958, filed Jun. 12, 2001.

### TECHNICAL FIELD

The invention relates to a film structure for a holographic film.

### BACKGROUND OF THE INVENTION

Holographic films are used more and more widely, particularly in the packaging of consumer goods. In an holographic structure, an embossed layer is covered with a metallic layer. This has the advantage of providing a three dimensional structure effect which is catching to the eye. However, this often requires redesign of the whole film structure, particularly due to the fact that the metallic layer is not a thermo-plastic layer but a thin metallic layer.

The present invention concerns an holographic structure comprising an organic solvent based embossed layer, a metallic layer located onto the embossed layer, and an organic solvent based printing ink layer.

Among the advantages of such a structure is the eye-catching effect which can be obtained by the combination of holographic techniques and the holographic techniques.

While having this and other advantages, such structures, particularly when integrated into laminated film structures, have disadvantages. For example, a typical film structure will comprise the organic solvent based lacquer printed or applied, prior to embossement, onto a first side of a polyester (PET) film, typically a 12 μm thick film. Once this lacquer is applied to this PET film, it is embossed so as to produce the holographic pattern. Once embossed, a metallic layer, typically aluminium, is vaporised or applied in another manner onto the embossed lacquer to form the “holographic core”. The PET side which is not covered by the embossed lacquer can be thereafter laminated to other films, for example a 180 μm thick PE poly-ethylene film. Once this is done, printing can occur. However, it was found that direct printing onto the metallic layer was leading to dissolution of the embossed layer by penetration of the ink solvents through the thin metallic layer.

However, all these film structure are showing dissolution of the embossed lacquer due to ink solvent going through the metallic layer.

The invention seeks to provide an holographic structure of the above mentioned kind which does not lead to dissolution of the embossed lacquer.

### SUMMARY OF THE INVENTION

In accordance with the invention, this object is accomplished in a holographic structure of the above mentioned kind in that the printing ink layer and the metallic layer are solely separated by a water solvent based primer.

A process in accordance with the invention has a number of advantages. Since the metallic layer and the printing ink layer are separated by the water solvent based primer, migration of the organic solvent from the ink layer to through the water solvent based primer is prevented, as the organic solvent was found not to migrate through a water solvent layer. Therefore, dissolution of the embossed lacquer by migration of the organic solvent present in the ink layer is avoided.

### DETAILED DESCRIPTION OF THE INVENTION

The invention relates to an holographic structure. By an holographic structure, it should be understood that the structure is exhibiting a three dimensional eye-catching impression based on the metallisation of an embossed layer. Indeed, according the holographic structure comprises an organic solvent based embossed layer. By organic solvent based, it should be understood that the layer is applied together with a solvent, for example by a printing technique, the solvent being organic. The layer is embossed by processes already known by the man skilled in the art of making holograms. Typically, embossement is obtained by application of a pressure onto the layer, so as to produce the pattern which will exhibit the holographic effect. This holographic effect is produced in combination with the metallic layer located onto the embossed layer. Typically, this metallic layer is an aluminium layer, which is applied by vaporisation, thereby giving a thickness of a few atomic layers. Further, the holographic structure comprises an organic solvent based printing ink layer. This layer may comprise one or more inks having various colours, these being typically applied by the usual printing techniques together with a solvent, which is an organic solvent in the structure of the invention. It should be mentioned that an organic solvent should be understood as being non aqueous. Additionally, the printing ink layer and the metallic layer are solely separated by a water solvent based primer. By solely separated, it should be understood that no laminated layers are to be found between the printing ink layer and the metallic layer. It is necessary that the primer is water-based so as to prevent migration of the solvent from the inks into the embossed layer through pin-holes which usually are present in the thin metallic layer. Indeed, migration of organic solvents through the metallic layer was found to dissolve the embossed layer. It should be understood that the primer could comprise several layers itself, although such layers should not be laminated but applied together with a water based solvent.

In a preferred embodiment, the embossed layer is formed from a lacquer applied to a thermoplastic film, the thermoplastic film being preferably a poly-ethylene-therephtalate film. In a more preferred embodiment, this thermoplastic film is laminated to another thermoplastic film, such as a polyethylene film for example.

In the most preferred embodiment according to the invention, the embossed layer is an acrylic based lacquer which is deposited on a 12 μm polyester film using toluene, butyl acetate or ketones as an organic solvent. This embossed layer is thereafter covered with an aluminium layer, which is itself covered with the water solvent based primer which is an aqueous based acrylic, as in a preferred embodiment whereby the water solvent based primer comprises acrylic compounds. The primer is therefore forming a barrier to the migration of the organic solvents comprised in the printed ink layer which is applied onto the primer. In this most preferred embodiment, a white ink and colored inks are printed, the white ink having an ethyl-acetate solvent and the coloured inks having an ethanol solvent. Indeed it was found preferable to use different organic solvents for the ink in order to avoid dissolution of a first ink when a second ink is applied. Indeed, in a preferred embodiment, the printing ink layer comprises a coloured ink and a white ink, the coloured ink having ethanol as an organic solvent and the white ink having ethyl-acetate as an organic solvent. A two-components lacquer is then applied onto the printed ink layer to protect the ink. The side of the PET film which is not covered by the embossed layer is then laminated to a 180 μm polyethylene film. A package made from this film laminate comprising an holographic structure according to the invention allows to avoid dissolution of the embossed layer while maintaining the holographic appearance. Further, this package revealed to be suitable for use as a refill pouch for laundry product when made according to the process described in EP626319. Further, this package can be used to contain up to 3 litters of liquid laundry product, filling occurring at normal production speed, without need for an enlarged head space as would be needed in case of a thicker and more rigid film. Another package is foreseen, whereby each side of the film is made from a thermoplastic material. This may be achieved by applying an extra thin layer of polyethylene, such that both sides of the film could be thermo-sealed. Such a package is particularly well suited for granules laundry products packaging.

What is claimed is:

1. A process of making a holographic structure comprising:
producing a pattern on an organic solvent based embossed layer to exhibit a holographic effect;
applying a metallic layer onto said embossed layer; and
applying a primer and a printing ink layer onto said metallic layer such that said printing layer and said metallic layer are solely separated by said primer,
wherein said primer is water solvent based and wherein said printing ink layer is organic solvent based.

2. The process of claim 1 further comprising the step of forming said embossed layer from a lacquer and applying said embossed layer to a thermoplastic film.

3. The process of claim 2 wherein said thermoplastic film is a polyester film.

4. The process of claim 2 further comprising the step of laminating said thermoplastic film to a second thermoplastic film.

5. The process of claim 1 wherein said metallic layer is an aluminum layer.

6. The process of claim 1 wherein said organic solvent based embossed layer is an acrylic based lacquer.

7. The process of claim 1 wherein said ink layer comprises a colored ink and a white ink, said colored ink comprising ethanol as an organic solvent and said white ink comprising ethyl-acetate as an organic solvent.

8. The process of claim 1 wherein said water solvent based primer comprises acrylic compounds.

9. A package made from a film laminate having a holographic structure made according to the process of claim 1.
